(19) United States
(12) Patent Application Publication
(10) Pub. No.: US 2009/0323849 A1
(43) Pub. Date: Dec. 31, 2009

(54) METHOD AND APPARATUS FOR PERFORMING MULTIPLE-INPUT MULTIPLE-OUTPUT WIRELESS COMMUNICATIONS

(75) Inventors: Erdem Bala, Farmingdale, NY (US); Kyle Jung-Lin Pan, Smithtown, NY (US); Donald Grieco, Manhasset, NY (US); Philip J. Pietraski, Huntington Station, NY (US); Sung-Hyuk Shin, Northvale, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/491,672

(22) Filed: Jun. 25, 2009

Related U.S. Application Data
(60) Provisional application No. 61/076,983, filed on Jun. 30, 2008.

(51) Int. Cl. H03M 7/00; H04L 27/00; H04L 1/02

(52) U.S. Cl. 375/267; 375/295; 341/106

(57) ABSTRACT

A method and an apparatus for performing multiple-input multiple-output (MIMO) wireless communications are disclosed. A Node-B may receive an index to a pre-coding matrix in a single user MIMO (SU-MIMO) pre-coding codebook from wireless transmit/receive units (WTRUs) and adaptively perform one of SU-MIMO or multi-user MIMO (MU-MIMO) based on a predetermined criterion. Channel information for performing MU-MIMO may be obtained based on the pre-coding matrix of the SU-MIMO pre-coding codebook. A rank requested by the WTRU may be overridden if the unitary MU-MIMO codebook is a subset of the SU-MIMO pre-coding codebook. If not, a MU-MIMO pre-coding matrix with a largest correlation to the pre-coding matrix may be selected. A WTRU may send a pre-coding matrix for transmission to the WTRU along with a preferred interference matrix. A WTRU may send rank information and multiple right singular vectors for MU-MIMO.

### CROSS REFERENCE TO RELATED APPLICATIONS

This application claims the benefit of U.S. provisional application No. 61/076,983 filed Jun. 30, 2008, which is incorporated by reference as if fully set forth.

### FIELD OF INVENTION

This application is related to wireless communications.

### BACKGROUND

Multiple-input multiple-output (MIMO) is a scheme using multiple antennas both at a transmitter and a receiver to improve wireless communication performance. MIMO has attracted attention in wireless communications since it offers significant increases in data throughput without additional bandwidth or transmit power.

Recently, multi-user MIMO (MU-MIMO) technology has been proposed. In MU-MIMO, the spatial channel is shared by multiple users. MU-MIMO is more feasible to low complexity wireless transmit/receive units (WTRUs) with small number of antennas than single user MIMO (SU-MIMO) with high system throughput capability.

Zero-forcing (ZF) beamforming is one of the schemes proposed for MU-MIMO. Assume that a Node-B has M transmit antennas and there are L active users and K out of L active users would be scheduled for simultaneous transmissions. Assume that the Node-B transmits a single data stream to each user (i.e., WTRU), and that each user has a single receive antenna. Let sₖ be the data symbol that would be transmitted to the k-th user, and Pₖ be the power allocated for the k-th user. The data symbol for each user is multiplied with a beamforming vector wₖ. The transmitted signal from the Node-B is given as

$${\sum }_{k = 1}^{K} {P}_{k} {w}_{k} {s}_{k} .$$

For user k, the received signal would be as follows:

$${y}_{k} = \sqrt{{P}_{k}} {h}_{k} {w}_{k} {s}_{k} + {\sum }_{j = 1 , j \neq k}^{K} \sqrt{{P}_{j}} {h}_{k} {w}_{j} {s}_{j} + {n}_{k} ; \qquad Equation ( 1 )$$

where hₖ denotes the channel from the user k to the Node-B. The first part of the received signal is the data stream transmitted to user k and the second part of the received signal is data transmitted to other users, (i.e., inter-user or inter-stream interference), and the third part of the received signal is the noise.

In ZF beamforming, the beamforming vectors are chosen such that hₖwⱼ=0, for k ≠ j. This condition guarantees that the interference from other users' data on user k is completely cancelled. One way of accomplishing the zero inter-user interference condition is to compute the beamforming vectors from the pseudo-inverse of the composite channel matrix. The composite channel matrix is defined as H=[h₁ h₂ . . . h_{K}] and the composite beamforming matrix is defined as W=[w₁ w₂ . . . w_{K}]. Then, the zero inter-user interference condition can be satisfied if W=H^{†}=H^{H}(=HH^{H})⁻¹. When H is poorly conditioned, the effective channel gain might be greatly reduced and degrades the performance of ZF beamforming. Therefore, for ZF beamforming, users are selected such that the channels are as orthogonal as possible. The beamforming matrix W may also be computed in different ways. For example, some inter-user interference may be tolerated by adding a constant such that W=H^{H}(HH^{H}+α)⁻¹.

To achieve the optimal performance of the ZF beamforming, perfect channel state information of all users is required at the Node-B. This is achieved by the WTRU estimating the channel and feeding this information back to the Node-B. Due to the practical limits on the capacity of the feedback channel, the number of bits to represent the channel is limited. Therefore, the estimated channel is quantized according to a given channel quantization codebook and an index from the quantization codebook is transmitted to the Node-B. Under these circumstances, the beamforming matrix W computed at the Node-B would not guarantee zero inter-user interference due to the channel quantization error.

Assume that the quantization codebook comprises N unit-norm vectors, and is denoted as C_{WTRU}={c₁, c₂, . . . , c_{N}}. Each WTRU first normalizes its channel h and chooses the closest codebook vector that could represent the channel. The normalization process removes the amplitude information and only the direction/spatial signature of the channel is retained. The amplitude information is transmitted in the channel quality indicator (CQI) feedback. Quantization may be performed according to the minimum Euclidian distance such that ĥₖ=cₙ,

$$n = arg {max}_{i = 1 , … , N} \vert {\tilde{h}}_{k} {c}_{i}^{H} \vert$$

where \tilde{h}ₖ denotes the normalized channel and ĥₖ is the quantized channel. The WTRU feeds back the index n to the Node-B.

Due to the channel quantization error, the condition hₖwⱼ=0, k ≠ j is not satisfied because the beamforming matrix W is computed by using the ĥₖ but not hₖ. Given that the received signal at user k is

$${y}_{k} = \sqrt{{P}_{k}} {h}_{k} {w}_{k} {s}_{k} + {\sum }_{j = 1 , j \neq k}^{K} \sqrt{{P}_{j}} {h}_{k} {w}_{j} {s}_{j} + {n}_{k} ,$$

the SINR at the user k becomes as follows:

$$S I N {R}_{k} = \frac{{P}_{k} {\vert {h}_{k} {w}_{k} \vert}^{2}}{{σ}^{2} + {\sum }_{i \neq k} {P}_{i} {\vert {h}_{k} {w}_{i} \vert}^{2}} ; \qquad Equation ( 2 )$$

where σ² denotes the noise variance. In order to compute the exact SINR, the WTRU has to know the beamforming vectors beforehand. This is not possible because the WTRU does not know other WTRU's channels.

Block diagonalization is an extension of the ZF beamforming method which may support multiple data streams for a user. When a WTRU has multiple receive antennas, the Node-B may send multiple streams to the WTRU. The ZF beamforming technique may be applied by treating the vector channel from the Node-B to each of the WTRU's antennas as a separate user. In this case, all of the streams transmitted by the Node-B are diagonalized. When the number of streams that may be supported by a given WTRU is smaller than the number of receive antennas, the dominant right singular vector(s) of the channel may be used to compute the ZF solution. In this case, diagonalization may be achieved by using the left singular vectors of the channel at the receiver.

Trying to force the interference among all streams to be zero consumes unnecessary power. An effective method is to design the pre-coders such that interference among different WTRUs' streams gets cancelled but the streams that go to the same WTRU are not necessarily interference-free. This technique is called “block diagonalization.”

Assume that the Node-B transmits to K users simultaneously and uses the pre-coding matrix Tᵢ for the i-th WTRU. The dimensions of Tᵢ is (the number of data streams for the i^{th} WTRU)×(the number of transmit antennas at the Node-B). Also, assume that the channel matrix for the i-th WTRU is denoted as Hᵢ. The received signal at the k-th WTRU may be written as follows:

$${r}_{k} = {H}_{k} {\sum }_{i = 1}^{K} {T}_{i} {b}_{i} + {n}_{k} = {H}_{k} {T}_{k} {b}_{k} + {H}_{k} {{\sum }_{i \neq k}}^{K} {T}_{i} {b}_{i} + {n}_{k} . \qquad Equation ( 3 )$$

A goal is to select the pre-coding matrices to cancel the interference term

$${H}_{k} {{\sum }_{i \neq k}}^{K} {T}_{i} {b}_{i} .$$

To achieve this, HᵢTₖ=[Hᵢtₖₗ . . . Hᵢt_{kM}]=0, i ≠ k, i.e., the pre-coding matrix used for the k-th WTRU does not cause any interference on the remaining WTRUs. This requires that the columns of the pre-coding matrix Tₖ lie in the null space of the channel matrices of the remaining (K−1) WTRUs. One method to compute the pre-coding matrix Tₖ is to find this null space by using the singular value decomposition (SVD). To do this, the channel matrices are stacked as follows:

Ĥₖ=[H₁^{T} . . . . Hₖ₋₁^{T} Hₖ₊₁^{T} . . . H_{K}^{T}]^{T}, Equation (4)

and the SVD of the composite matrix is performed as follows:

$${\hat{H}}_{k} = {U}_{k} [ \begin{matrix}Σ & 0 \\ 0 & 0\end{matrix} ] [ \begin{matrix}{\tilde{V}}_{k}^{H} \\ {\overline{V}}_{k}\end{matrix} ] . \qquad Equation ( 5 )$$

The pre-coding matrix may be written as:

Tₖ= V̅ₖAₖ, Equation (6)

where V̅ₖ guarantees that the interference from the k-th WTRU's data on other WTRUs is zero, (i.e, the MU-MIMO system is transformed into K block diagonal SU-MIMO systems). The matrix Aₖ may be designed by using any of the conventional SU-MIMO optimization technique.

### SUMMARY

A method and an apparatus for performing MIMO wireless communications are disclosed. A Node-B may receive an index to a pre-coding matrix in a SU-MIMO pre-coding codebook from WTRUs and adaptively perform one of SU-MIMO or MU-MIMO based on a predetermined criterion. Channel information for performing MU-MIMO may be obtained based on the pre-coding matrix of the SU-MIMO pre-coding codebook. A rank requested by the WTRU may be overridden if the unitary MU-MIMO codebook is a subset of the SU-MIMO pre-coding codebook. If not, a MU-MIMO pre-coding matrix with a largest correlation to the pre-coding matrix may be selected. A WTRU may send a pre-coding matrix for transmission to the WTRU along with a preferred interference matrix. A WTRU may send rank information and multiple right singular vectors for MU-MIMO.

### BRIEF DESCRIPTION OF THE DRAWINGS

A more detailed understanding may be had from the following description, given by way of example in conjunction with the accompanying drawings wherein:

FIG. 1 is a functional block diagram of an example WTRU and an example Node-B; and

FIG. 2 is a flow diagram of an example process of adaptively selecting a MIMO scheme in accordance with the one embodiment.

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “Node-B” includes but is not limited to a base station, an evolved Node-B, a site controller, an access point (AP), or any other type of interfacing device capable of operating in a wireless environment.

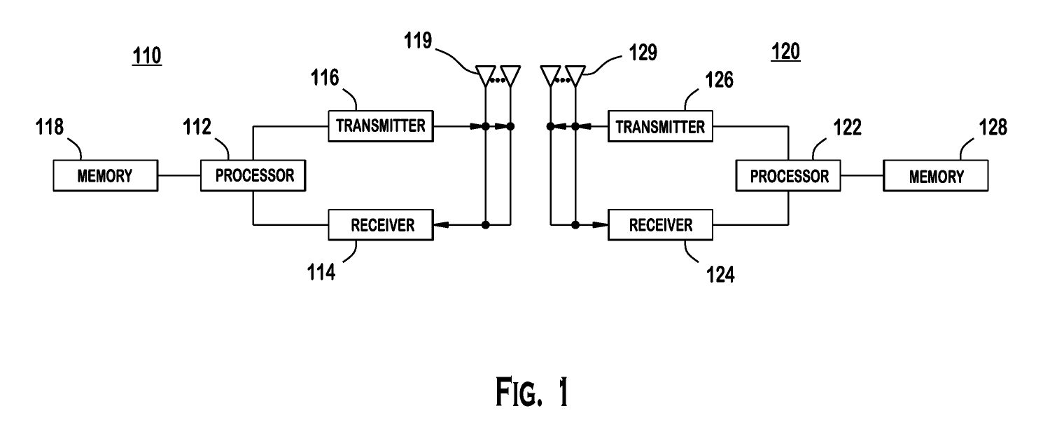

FIG. 1 is a functional block diagram of an example WTRU 110 and an example Node-B 120. The WTRU 110 is in communication with the Node-B 120 and both are configured to perform a method of performing MIMO wireless communications.

In addition to the components that may be found in a typical WTRU, the WTRU 110 includes a processor 112, a receiver 114, a transmitter 116, a memory 118 and an antenna 119. The memory 118 is provided to store software including operating system, application, etc. The processor 112 is provided to perform, alone or in association with the software, a method of a method of performing MIMO wireless communications. The receiver 114 and the transmitter 116 are in communication with the processor 112. The antenna 119 is in communication with both the receiver 114 and the transmitter 116 to facilitate the transmission and reception of wireless data.

In addition to the components that may be found in a typical Node-B, the Node-B 120 includes a processor 122, a receiver 124, a transmitter 126, a memory 128, and an antenna 129. The processor 122 is configured to perform, along or in association with the software, a method of a method of performing MIMO wireless communications. The receiver 124 and the transmitter 126 are in communication with the processor 122. The antenna 129 is in communication with both the receiver 124 and the transmitter 126 to facilitate the transmission and reception of wireless data.

In accordance with a first embodiment, block diagonalization is implemented with quantized channel information. In this method, the Node-B is provided with quantized channel information, (i.e., index to the quantization codebook), and the Node-B uses this information to compute the pre-coding matrices. In this case, due to the quantization error, the interference cannot be completely removed.

Channel quantization may be carried out in different ways. A single quantization codebook may be used such that the size of the vectors of the quantization codebook is (the number of transmit antennas at the Node-B)×1. Each column of the channel matrix may be quantized separately and fed back to the Node-B by using a certain number of bits. Alternatively, matrix quantization may be performed with a quantization codebook comprising matrices for every possible combination of transmit and receive antennas.

In general, the number of data streams transmitted to a WTRU should be smaller than the number of receive antennas. Therefore, instead of feeding back the full channel information, information about the dominant right singular vector(s) of the channel matrix may be sent. It has been shown that pre-coding in the direction of the eigenvectors of the channel correlation matrix H^{H}H or equivalently the right singular vectors of the channel matrix H is optimal. Diagonalization may be achieved with proper receive processing, which will be shown below. The number of singular vectors fed back to the Node-B is called the rank. The quantization codebook may comprise vectors or matrices. As an example, assuming that the quantization codebook comprises 16 vectors and the channel has 4 singular vectors, if the WTRU determines that it requires two data streams by using the two dominant singular vectors, the WTRU may quantize each of these singular vectors separately and feed back to the Node-B by using 4 bits for each of them. The feedback overhead may be reduced by using techniques such as differential coding, or the like.

How the interference may be cancelled when the singular vectors of the channel are used is explained hereafter. Assume that the SVD of the channel may be written as:

$${H}_{k} = [ \begin{matrix}{U}_{k 1} & {U}_{k 2}\end{matrix} ] [ \begin{matrix}Σ & 0 \\ 0 & 0\end{matrix} ] [ \begin{matrix}{V}_{k 1}^{H} \\ {V}_{k 2}^{H}\end{matrix} ] . \qquad Equation ( 7 )$$

The WTRU feeds back one or more of the right singular vectors Vₖ₁. These vectors are used to compute the pre-coding matrices at the Node-B as explained above.

After the pre-coding matrices are computed and used for transmission, the received interference may be written as follows:

$$\begin{matrix}{int}_{k} = {H}_{k} {\sum }_{i = 1 , i \neq k}^{K} {T}_{i} {b}_{i} \\ = [ \begin{matrix}{U}_{k 1} & {U}_{k 2}\end{matrix} ] [ \begin{matrix}Σ & 0 \\ 0 & 0\end{matrix} ] [ \begin{matrix}{V}_{k 1}^{H} \\ {V}_{k 2}^{H}\end{matrix} ] {\sum }_{i = 1 , i \neq k}^{K} {T}_{i} {b}_{i} ,\end{matrix} \qquad Equation ( 8 )$$

where the SVD of the channel matrix is used. It may be written as follows:

$${int}_{k} = {\sum }_{i = 1 , i \neq k}^{K} {U}_{k 1} \tilde{Σ} {V}_{k 1}^{H} {T}_{i} {b}_{i} + {U}_{k 2} \tilde{Σ} {V}_{k 2}^{H} {T}_{i} {b}_{i} , \\ where \tilde{Σ} = [ \begin{matrix}Σ & 0 \\ 0 & 0\end{matrix} ] . \qquad Equation ( 9 )$$

Due to the design of the pre-coding matrices, the first interference term is zero. However, the second term is not cancelled. Then, the corresponding left singular vectors are used at the WTRU as follows:

$$\begin{matrix}{U}_{k 1}^{H} r = {U}_{k 1}^{H} {H}_{k} {T}_{k} {b}_{k} + {\sum }_{i = 1 , i \neq k}^{K} {U}_{k 1}^{H} {U}_{k 1} \tilde{Σ} {V}_{k 1}^{H} {T}_{i} {b}_{i} + \\ {U}_{k 1}^{H} {U}_{k 2} \tilde{Σ} {V}_{k 2}^{H} {T}_{i} {b}_{i} + {U}_{k 1}^{H} {n}_{k} \\ = {U}_{k 1}^{H} {H}_{k} {T}_{k} {b}_{k} + {U}_{k 1}^{H} {n}_{k} .\end{matrix} \qquad Equation ( 10 )$$

The interference is then cancelled. When the WTRU requires only a single data stream as in ZF beamforming, only one right singular vector is fed back to the Node-B. In this case, the Node-B uses only one beamforming vector to pre-code the single data stream.

In accordance with a second embodiment, a codebook-based approach is used to implement block diagonalization with partial feedback. The pre-coding matrix used by the Node-B for a specific WTRU in accordance with the first embodiment is unitary, (i.e., the pre-coding vectors for different streams are orthogonal). This is because the pre-coding matrix comprises the right singular vectors of the composite channel and these vectors are orthogonal to each other. The vectors used to pre-code the data streams for different WTRUs are not necessarily orthogonal. Therefore, if a codebook (i.e., pre-coding codebook) that satisfies these constraints is used, a codebook-based approach may be used to implement block diagonalization.

There are several ways of generating this codebook and signaling this to the WTRU. The codebook may comprise unitary matrices. The WTRU signals which matrix is preferred for transmission to itself. The Node-B may then use the remaining matrix or matrices for other users. The WTRU may select a preferred interfering matrix from the codebook and signal it to the Node-B. For example, assume that the codebook comprises three matrices M₁, M₂, and M₃, and each matrix has two vectors that can be used to pre-code two data streams. If a WTRU prefers M₁, then either M₂ or M₃ may be used for another WTRU and this will cause interference on the first WTRU. The first WTRU may indicate which matrix it prefers as an interference. When a CQI is computed, either the exact CQI may be computed when all the remaining matrices are to be used, or an average or worst case CQI may be computed, which will be explained in detail below. Based on the CQI, the WTRU may choose not to signal the preferred interfering matrix because the average or worst case CQI may be above a given threshold. If there are more vectors in the selected matrix than the number of data streams, the indices of the preferred vectors also need to fed back to the Node-B.

Alternatively, the codebook may have matrices that contain orthogonal and non-orthogonal vectors. For example, the codebook elements may be M=[v₁ v₂ v₃ v₄] where the vectors v₁ and v₂ are orthogonal to each other and the vectors v₃ are v₄ are orthogonal to each other. A WTRU may prefer v₁ and v₂ to be used to pre-code its data streams and v₃ are v₄ to be used for pre-coding data streams of other WTRUs. When a codebook-based approach is used, the size of the codebook may not be too large not to limit the possibility of pairing WTRUs.

In accordance with a third embodiment, a unitary pre-coding is used for MU-MIMO. In block diagonalization, the pre-coding vectors used for different WTRUs are not orthogonal in general. In unitary pre-coding, the Node-B uses orthogonal pre-coding vectors for different WTRUs.

The unitary pre-coding codebook comprises unitary matrices. A WTRU selects one of the pre-coding vectors in a unitary matrix and signals the index of this vector to the Node-B. All or some of the remaining vectors in the selected unitary matrix may be used to pre-code the data for other paired WTRU(s). In unitary pre-coding, the SINR measurement is more accurate because the interfering pre-coding vector(s) are either exactly known or known with high precision. For example, if the unitary matrix is given as M=[v₁ v₂], and a WTRU selects v₁ as the preferred pre-coding vector, v₂ would be the interfering vector. Similarly, if M=[v₁ v₂ v₃] is the unitary matrix, then the interfering vector would be either v₂ or v₃, assuming that only two WTRUs are paired and each one gets a single data stream.

To support multiple streams per WTRU with unitary pre-coding, each WTRU needs to send the number of data streams requested and the indices of the pre-coding vectors from the selected unitary matrix. In unitary pre-coding, the codebook needs to be small because the probability of WTRUs being paired decreases as the number of matrices in the codebook increases. If a non-unitary coupling is allowed, the restriction on the scheduling may be eased.

Embodiments for adaptively selecting one of the SU-MIMO and MU-MIMO are disclosed hereafter. A common uplink and downlink signaling framework is provided to enable adaptive selection of one of the SU-MIMO and MU-MIMO.

In accordance with a fourth embodiment, a WTRU feeds back information to the Node-B that is common and adequate to be used to implement any of the MU-MIMO techniques, (e.g., either zero-forcing or unitary pre-coding MU-MIMO). Multiple streams per WTRU may also be supported. In an ideal situation where the Node-B has perfect channel state information of all WTRUs, any MIMO schemes (SU-MIMO or MU-MIMO) may be used. The commonality between zero-forcing, unitary pre-coding, or any other MIMO technique is the channel state information.

As explained above, ZF beamforming and block diagonalization require channel state information. When the channel state information is available, the pre-coding matrices W for ZF or block diagonalization may be computed as shown above, i.e., the WTRU computes the SVD of the channel matrix by

$${H}_{k} [ \begin{matrix}{U}_{k 1} & {U}_{k 2}\end{matrix} ] [ \begin{matrix}Σ & 0 \\ 0 & 0\end{matrix} ] [ \begin{matrix}{V}_{k 1}^{H} \\ {V}_{k 2}^{H}\end{matrix} ]$$

and feeds back some or all of the eigenvectors Vₖ₁ to the Node-B. The Node-B then computes the pre-coding matrix W. The number of the fed back eigenvectors is equal to the number of data streams (rank) requested. In unitary pre-coding or any other codebook-based approach, the WTRU uses the channel information to select the best pre-coding vector(s) and sends the selection decision to the Node-B, (i.e., the channel information is used by the WTRU, not by the Node-B as in ZF beamforming). If the Node-B has the channel information, the Node-B would be able to perform the same processing and select the best pre-coding vector(s) from the pre-coding codebook.

In ZF beamforming or block diagonalization, the channel quantization precision should be good enough to prevent any performance degradation due to the quantization error. Therefore, the size of the channel quantization codebook cannot be very small. On the other hand, in a codebook-based pre-coding approach, the pre-coding codebook size should be small to make WTRU pairing easier.

It has been shown that, for MIMO transmission, the optimal pre-coding vector(s) need to match the eigendirection(s) of the channel. Therefore, in unitary pre-coding, one of the criteria for selecting the best pre-coding vector(s) tᵢ is the correlation between candidate pre-coding vector(s) in the codebook and the dominant right singular vector(s) of the channel, Vₖ₁. This means that the pre-coding vector for the k^{th} WTRU may be found as

$${t}_{k} = {c}_{n} \qquad n = arg {max}_{i = 1 , … , N} \vert {V}_{k 1} {c}_{i}^{H} \vert$$

where cᵢ are the candidate pre-coding vectors from a unitary matrix in the codebook. When a pre-coding vector is selected as a candidate, the remaining pre-coding vectors from the same unitary matrix are treated as possible interference sources. Then, the final selection may be based on a signal-to-noise-interference (SINR) criterion. For example, if a WTRU selects the n-th pre-coding vector from a unitary matrix with M vectors by using the most dominant singular vector V, the SINR may be written as follows:

$$SINR = \frac{{\vert {V}^{T} {t}_{n} \vert}^{2}}{{{\sum }_{l = 1 , l \neq n}}^{M} {\vert {V}^{T} {t}_{l} \vert}^{2} + {σ}_{n}^{2}} . \qquad Equation ( 11 )$$

If Vₖ₁ were available at the Node-B, the pre-coding vector selection may also be done by the Node-B but perfect Vₖ₁ are practically not available in most cases. However, quantized version of Vₖ₁, \hat{V}ₖ₁, is in fact used for ZF beamforming or block diagonalization and should be available at the Node-B if these techniques are being used. The Node-B may also use this information for unitary pre-coding vector selection, i.e.,

$${t}_{k} = {c}_{n} \qquad n = arg {max}_{i = 1 , … , N} \vert {\hat{V}}_{k 1} {c}_{i}^{H} \vert .$$

The SINR criterion or another similar criterion may also be used for this purpose.

The selected pre-coding vector from the unitary codebook by using the quantized and unquantized channel information should be the same most of the time. This means that if the WTRU feeds back the quantized channel information, then the Node-B may use either the ZF beamforming or the unitary pre-coding approach. If the WTRU's feedback comprises quantized channel information, the Node-B may use any of the MU-MIMO techniques. If the WTRU feedbacks the indices of the preferred pre-coding vector(s), the Node-B may also implement ZF beamforming. In this case, the Node-B finds the quantized channel vector(s) from the quantization codebook that have the largest correlation to the selected pre-coding vector(s) and use them for ZF pre-coding.

The procedures for the unified MU-MIMO scheme are the same whether a single stream or multiple streams is supported. The only difference is that, when multiple streams are supported, more than one eigenvector is fed back to the Node-B.

In accordance with a fifth embodiment, one of SU-MIMO and MU-MIMO is selected adaptively based on predetermined criteria, such as traffic, data rate requirements, capacity, or the like. Dynamic adaptation between SU-MIMO and MU-MIMO may improve the performance of MIMO schemes. A WTRU may be scheduled in SU-MIMO or MU-MIMO mode over different frequency bands and subframes and the adaptation gives the Node-B significant freedom in scheduling. To achieve this, a common signaling and feedback framework is provided to accommodate SU-MIMO and different MU-MIMO schemes. As explained above, the channel state information is the commonality among all MIMO schemes. If the Node-B has this information, the Node-B would be able to use any MIMO technique and optimize the performance.

In SU-MIMO, the pre-coding codebook comprises rank 1 to rank Nᵣ matrices where Nᵣ is the maximum number of receive antennas at the WTRU. The pre-coding vector(s) from this codebook is selected by the WTRU and signaled to the Node-B. In general, the selection criterion is finding the vector(s) that best match the eigendirection(s) of the channel so that received signal power may be maximized. Therefore, the SU-MIMO codebook may, in fact, be used as the channel quantization codebook. This means that, when the Node-B has the information about which SU-MIMO pre-coding matrix is preferred by the WTRU, the pre-coding matrix also contains the quantized channel information. Once the Node-B determines which SU-MIMO pre-coding matrix is preferred by the WTRU, any MU-MIMO technique may be applied.

Getting the channel state information from the selected SU-MIMO pre-coding matrix may be achieved in different ways. Firstly, the columns in the preferred pre-coding matrix, (i.e., the pre-coding vectors for each data stream), may be used as quantized singular vectors of the channel. Alternatively, a separate channel quantization codebook may be used. In this case, the vector(s) from the quantization codebook that have the largest correlation to the preferred SU-MIMO pre-coding vector(s) may be used as the quantized channel information. Once the quantized channel information is created by any of these approaches, one of the MU-MIMO techniques may be used.

In accordance with the fifth embodiment, a WTRU, by default, feeds back the required information for SU-MIMO pre-coding (the selected pre-coding matrix). By using this information, the Node-B determines the quantized channel information. Then, either SU-MIMO by using the fed back pre-coding matrix from the SU-MIMO codebook or any of the MU-MIMO techniques may be applied.

For codebook-based MU-MIMO techniques, (such as the unitary pre-coding technique), adaptation between SU-MIMO and MU-MIMO may be achieved by selecting the best MU-MIMO codebook element from the preferred SU-MIMO pre-coding matrix. The MU-MIMO codebook may be a subset of the SU-MIMO codebook or may be different. If the MU-MIMO codebook is a subset of the SU-MIMO codebook, selecting the appropriate MU-MIMO pre-coding vector(s) may be done in two ways. Firstly, if the preferred SU-MIMO pre-coding vector(s) is included in the MU-MIMO codebook, it may be used directly. However, this approach might limit the scheduling capability of the Node-B when the size of the MU-MIMO codebook is small. Alternatively, the Node-B may try to find the vector(s) from the MU-MIMO codebook that best match the preferred SU-MIMO codebook element and use these vector(s). This correlation based approach may also be used when the MU-MIMO codebook is not a subset of the SU-MIMO codebook.

This adaptation may be extended to the special case for the current third generation partnership project (3GPP) Release 8 long term evolution (LTE) structure. The SU-MIMO codebook in Release 8 has a nested structure to enable rank overriding. The codebook is designed such that pre-coding matrices of rank r contain all codebook elements of rank smaller than r. If the Node-B wants to use a smaller rank than what a WTRU reports, the pre-coding matrix with the new rank may easily be found from the reported pre-coding matrix. In addition to this, the rank-1 SU-MIMO codebook may be used for MU-MIMO. A WTRU that is configured to be in MU-MIMO mode selects the best pre-coding vector from this codebook and reports it to the Node-B with a CQI value. The Node-B then may use the reported vector to pre-code the WTRU's data. With this scheme, adaptation between SU-MIMO and MU-MIMO is reduced to a rank overriding operation. Assume that the WTRU feeds back to the Node-B the preferred SU-MIMO pre-coding matrix of rank r, but the Node-B decides to use rank r-1 for the WTRU. The corresponding pre-coding vector is then found by using the nested architecture of the codebook. This vector may also be used for MU-MIMO transmission. Therefore, adaptation from SU-MIMO to MU-MIMO comprises finding the corresponding rank r-1 pre-coding vector from the SU-MIMO feedback. If the sizes of the rank r-1 SU and MU MIMO codebooks are the same, there is a one-to-one mapping. If codebooks of different sizes are used, some of the SU-MIMO pre-coding vector(s) might not be present in the MU-MIMO codebook. Then, the vector(s) in the MU-MIMO codebook that has the largest correlation to the selected SU-MIMO pre-coding vector(s) may be used. With this type of structure, adaptation between SU-MIMO and MU-MIMO may be transparent to the WTRU if the interfering WTRUs' pre-coding vectors are not being transmitted. The Node-B only needs to signal to the WTRU that rank r-1 transmission is being used. To achieve this, the same control signaling format needs to be used for SU-MIMO and MU-MIMO.

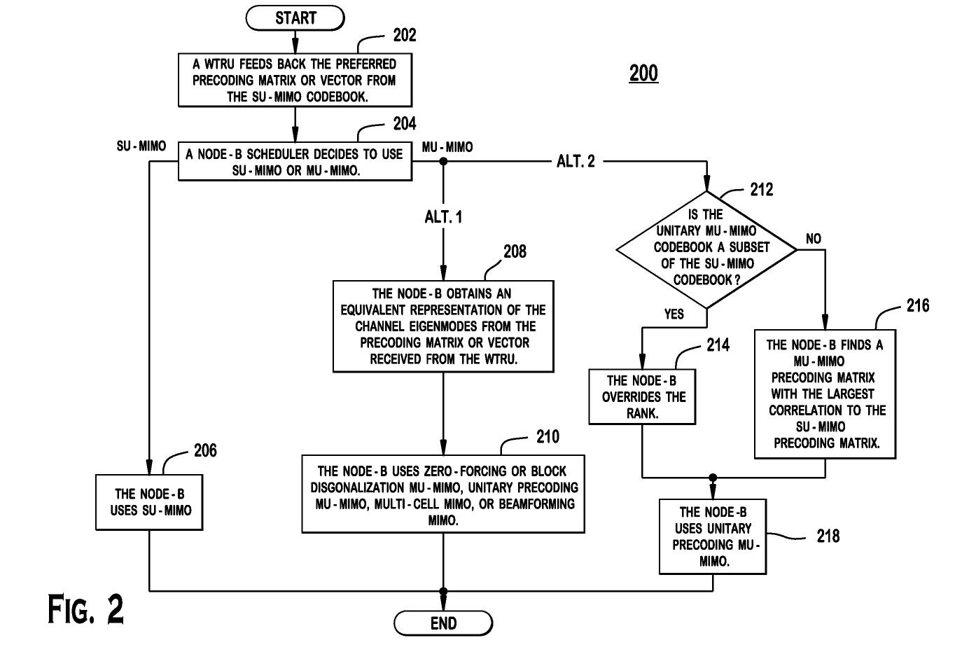

FIG. 2 is a flow diagram of an example process 200 of adaptively selecting a MIMO scheme in accordance with the one embodiment. A WTRU feeds back the preferred pre-coding matrix or vector from the SU-MIMO codebook (step 202). The Node-B scheduler decides to use SU-MIMO or MU-MIMO (step 204). If the Node-B decides to use SU-MIMO, the Node-B uses SU-MIMO (step 206). If the Node-B decides to use MU-MIMO, the Node-B obtains an equivalent representation of the channel eigenmodes from the pre-coding matrix or vector received from the WTRU, (i.e., the Node-B obtains the dominant singular vectors from the pre-coding matrix or vector) (step 208). The Node-B then uses ZF or block diagonalization MU-MIMO, unitary pre-coding MU-MIMO, multi-cell MIMO, or beamforming MIMO based on the obtained channel information (step 210). Alternatively, the Node-B may determine whether the unitary MU-MIMO codebook is a subset of the SU-MIMO codebook (step 212). If the MU-MIMO codebook is a subset of the SU-MIMO codebook, the Node-B overrides the rank and performs a unitary pre-coding MU-MIMO (steps 214, 216). If the MU-MIMO codebook is not a subset of the SU-MIMO codebook, the Node-B finds a MU-MIMO pre-coding matrix with the largest correlation to the SU-MIMO pre-coding matrix, and performs a unitary pre-coding MU-MIMO (steps 218, 220).

The quantized channel information or preferred pre-coding matrixes do not contain any information about the magnitude of the channel. They only have direction information. Therefore, in addition to the quantized channel state information or the preferred pre-coding matrix, a WTRU has to feed back to the Node-B a CQI. A CQI is generally based on the expected received SINR on a given channel. The accuracy of the CQI affects the system performance significantly.

When ZF beamforming is used for MU-MIMO transmission, an SINR may not be predicted exactly. The received SINR is as follows:

$$S I N {R}_{k} = \frac{{p}_{k} {\vert {h}_{k} {w}_{k} \vert}^{2}}{{σ}^{2} + {\sum }_{i \neq k} {p}_{i} {\vert {h}_{k} {w}_{i} \vert}^{2}} . \qquad Equation ( 12 )$$

Because the WTRU does not know which vectors would be used for transmission, the WTRU may either use a lower bound for the CQI, or get an estimate of an average CQI. The average CQI is computed by considering all possible combinations of the beamforming vectors. A rule may also be setup in advance that the K most interfering vectors will not be paired with its vector prior to estimating the worst case, best case, average, median or any other statistic of the effective CQI. The same is also true for block diagonalization. In block diagonalization, the interference term should also include the inter-stream interference similar to the SU-MIMO case.

In SU-MIMO, the SINR of each data stream may be exactly computed because the pre-coding vectors for all of the streams are known. In this case, the interference is due to the inter-stream interference.

Although the SINR may be estimated for each stream separately, the CQI value may be per stream or per codeword, where a codeword may comprise one or more streams. In this case, a stream to codeword mapping is needed.

To have an adaptive and unified SU and MU MIMO scheme, the CQI fed back by the WTRU needs to be accurate enough for all possible MIMO schemes. One way to achieve this is to use the SU-MIMO CQI for MU-MIMO transmission. If the WTRU has multiple receive antennas, the inter-user interference may be reduced with proper receive processing. Another method is for the Node-B to compensate for the inter-user interference after it pairs the WTRUs and update the reported CQI value by using an estimate of the inter-user interference.

Assume that a WTRU feeds back a CQI value based on the SU-MIMO SINR such as

$$S N {R}_{k} = \frac{{p}_{k} {\vert {h}_{k} {w}_{k} \vert}^{2}}{{σ}^{2}}$$

where the inter-cell interference is not shown. After the Node-B pairs another WTRU (i-th WTRU, for example) with this WTRU, the inter-user interference would be Intₖ=pᵢ|hₖwᵢ|². Then, the Node-B may compensate for this interference in the reported CQI and, for example, use a lower CQI for modulation and coding scheme (MCS).

Alternatively, the WTRU may feed back two CQI values. The first value is based on SU-MIMO and ignores the inter-user interference. The second CQI value is an estimate of the inter-user interference in case MU-MIMO is used for this WTRU. This approach would increase the signaling overhead but this increase can be kept to a minimum by using techniques such as differential encoding.

In the adaptive system, SU-MIMO or MU-MIMO may be dynamically used per a group of subcarriers in a given subframe, and the Node-B has to signal the required parameters to the WTRU. Because the pre-coding matrices are different for different MIMO schemes, the Node-B has to signal to the WTRU whether SU-MIMO or MU-MIMO is being used for a specific group of resource blocks (RBs). The Node-B also has to signal to the WTRU which MU-MIMO scheme is being used because the associated downlink control signaling of different MU-MIMO schemes is different.

When adaptation is being done between SU-MIMO and a codebook based MU-MIMO, (such as unitary pre-coding), the WTRU needs to know which technique is being used because the codebooks are different in general. The Node-B needs to signal if SU-MIMO or MU-MIMO is used per resource block group (RBG) that is scheduled for the WTRU. If the MU-MIMO pre-coding matrix may be computed from the SU-MIMO pre-coding matrix, the WTRU may compute the MU-MIMO pre-coding matrix and the Node-B does not need to signal it. In this case, it would be enough for the Node-B to confirm the selection made by the WTRU and signal whether SU-MIMO or MU-MIMO is used. If the adaptation affects the whole bandwidth, it may be indicated with a single bit or state.

When adaptation is performed between SU-MIMO and non-codebook based MU MIMO, (such as ZF beamforming), the WTRU needs to know if adaptation is used or not. Contrary to the unitary pre-coding, in ZF beamforming, the WTRU cannot compute the pre-coding matrix. Therefore, it has to be signaled either in the control channel or by using dedicated reference signals (RSs). If adaptation affects the whole bandwidth, it may be indicated with a single bit or state. For dynamic adaptation, a single control channel format needs to be used. With frequency selective ZF beamforming and if the pre-coding matrix is signaled, the size of the control channel would depend on the number of paired WTRUs per RBG and number of scheduled RBGs. This is not desirable. The same control channel format may be used by using dedicated RSs to signal the pre-coding matrices. For non-frequency selective ZF beamforming, the pre-coding matrix may also be signaled in the control channel. For some special cases, adaptation may be transparent to the WTRU. For dynamic adaptation, a single control channel format needs to be used.

The embodiments disclosed above may be used in multi-cell MIMO configurations as well instead of single cell MIMO. In multi-cell MIMO, different Node-Bs act as a single Node-B and transmit collaboratively to WTRUs which may be in different cells. During this transmission, MU-MIMO techniques disclosed above may be used so that each WTRU receives an interference-free transmission. This would especially improve the performance of cell-edge users significantly.

The channel from a given WTRU to its serving Node-B should be known as well as the channels from this WTRU to other Node-Bs that cooperate with the serving Node-B. Therefore, the WTRU needs to estimate the channel from other Node-Bs, quantize it, and send it to the serving Node-B. This channel information is then shared among the cooperative Node-Bs. Multi-cell MIMO may be implemented adaptively. Because multi-cell MIMO would be most beneficial for the WTRUs at the cell-edge, this scheme may be configured semi-statically and be used for longer time durations.

Beamforming based SU-MIMO and ZF MU-MIMO may be adaptively selected. Beamforming is a MIMO scheme that may be used to provide array gain. It is mostly used in correlated channels where the antenna spacing is small and the angular spread of the channel is low. Under these conditions, the transmitter may form a directed beam towards the receiver.

One way of implementing beamforming is to have a codebook that contains possible beamforming vectors. A WTRU selects the best vector from this codebook and feeds this information to the Node-B. Then, the selected vector is used by the Node-B for data transmission. For example, all or part of the rank-1 SU-MIMO codebook may be used as the beamforming codebook.

Alternatively, the long term statistics of the channel may be estimated and used to implement beamforming. In this case, a beamforming codebook is not required at the Node-B. The Node-B estimates the correlation matrix of the channel from the uplink transmission. For example, the Node-B estimates R=E(H₁^{H}H₁). Then, the eigenvector of the correlation matrix corresponding to the largest eigenvalue may be used as the beamforming vector. Alternatively, another beamforming vector may be computed by using the eigenvectors of different WTRUs, for example, to minimize the inter-user interference.

Zero-forcing beamforming for MU-MIMO may be adaptively used with SU-MIMO beamforming. When a non-codebook based approach is used, the eigenvector of the estimated channel correlation matrix may either be used as the beamforming vector for SU-MIMO or may be used to compute the pre-coding matrix for the ZF MU-MIMO. Then, the beamforming vectors need to be signaled with dedicated RSs. If the Node-B does not signal the interfering WTRUs' beamforming vectors in MU-MIMO mode, using SU-MIMO or MU-MIMO would be transparent to the WTRU. The WTRU only needs to compute the beamforming vector from the dedicated RS.

With a codebook-based approach, the adaptive scheme would be similar to the adaptive SU-MIMO or MU-MIMO method described above. The quantized channel may be created from the selected beamforming vector and then be used to compute the pre-coding matrix for ZF MU-MIMO. Similarly, if the interfering WTRUs' pre-coding vectors are not signaled, then the adaptation operation may be transparent to the WTRU. This requires that both SU-MIMO beamforming and ZF beamforming based MU-MIMO use the same control signaling format.

Different MIMO schemes are more optimal for certain channel conditions and antenna configurations and less optimal for others. For example, spatial multiplexing-based SU-MIMO that transmits one or more data streams is preferable for uncorrelated channels. On the other hand, a beamforming scheme transmits a single data stream and is usually used in correlated channels with closely spaced antennas. A similar distinction may be made for MU-MIMO schemes as well. ZF beamforming-based MU-MIMO, for example, may be more preferable for configurations with closely spaced antennas.

Based on these considerations, a semi-static configuration may be used for SU-MIMO and MU-MIMO. The SU-MIMO and MU-MIMO schemes are configured by the Node-B with higher layer signaling and the adaptation rule between the SU-MIMO and MU-MIMO schemes is decided in advance. For example, beamforming for SU-MIMO and ZF beamforming for MU-MIMO may be configured. Alternatively, codebook based SU-MIMO and unitary pre-coding based MU-MIMO may be configured. Once this configuration is done, the appropriate adaptation between SU-MIMO and MU-MIMO is used.

The adaptation between SU-MIMO and MU-MIMO may also be configured. In this case, dynamic adaptation between SU-MIMO and MU-MIMO is not required. With such configuration, different codebooks for different schemes and the corresponding codebook and signaling scheme may be used with the given configuration. As an example, a part of the bandwidth may be reserved for MU-MIMO. The appropriate codebook, CQI computation, and signaling for this part of the bandwidth are then based on the selected MU-MIMO scheme. For example, if ZF beamforming-based MU-MIMO is being used, a channel quantization codebook may be used and the WTRU feeds back the quantized channel information to the Node-B. The CQI computation for this part of the bandwidth may take into account the inter-user interference. The pre-coding vectors may be signaled in this part of the bandwidth with dedicated RSs.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for performing multiple-input multiple-output (MIMO) wireless communications, the method comprising:
receiving one of an index to a pre-coding matrix in a single user MIMO (SU-MIMO) pre-coding codebook or SU-MIMO channel information from a plurality of wireless transmit/receive units (WTRUs); and
adaptively performing one of SU-MIMO and multi-user MIMO (MU-MIMO) based on a predetermined criterion, wherein channel information for performing MU-MIMO is obtained based on one of the pre-coding matrix of the SU-MIMO pre-coding codebook or the SU-MIMO channel information received from the WTRUs.

2. The method of claim 1 further comprising:
determining whether a unitary MU-MIMO codebook is a subset of the SU-MIMO pre-coding codebook;
overriding a rank requested by a WTRU on a condition that the unitary MU-MIMO codebook is a subset of the SU-MIMO pre-coding codebook; and
performing a unitary pre-coding MU-MIMO.

3. The method of claim 1 further comprising:
determining whether a unitary MU-MIMO codebook is a subset of the SU-MIMO pre-coding codebook;
finding a MU-MIMO pre-coding matrix with a largest correlation to the pre-coding matrix on a condition that the unitary MU-MIMO codebook is not a subset of the SU-MIMO pre-coding codebook; and
performing a unitary pre-coding MU-MIMO.

4. The method of claim 1 wherein one of zero-forcing MU-MIMO, block diagonalization MU-MIMO, multi-cell MIMO, or beamforming MIMO is implemented based on the channel information.

5. The method of claim 1 wherein the index to the pre-coding matrix in the SU-MIMO pre-coding codebook or the SU-MIMO channel information for a plurality of cells that are participating for multi-cell MIMO are obtained and multi-cell MIMO is implemented.

6. The method of claim 1 wherein a vector from a quantization codebook that has a largest correlation to the pre-coding matrix is used as the channel information for performing MU-MIMO.

7. The method of claim 1 further comprising:
receiving a channel quality indicator (CQI) computed based on SU-MIMO signal-to-interference and noise ratio (SINR).

8. The method of claim 7 further comprising:
receiving a second CQI indicating an inter-user interference in MU-MIMO.

9. A method implemented in a wireless transmit/receive unit (WTRU) for performing multiple-input multiple-output (MIMO) wireless communications, the method comprising:
performing MIMO channel estimation;
sending one of an index to a single user MIMO (SU-MIMO) pre-coding matrix in a code book or SU-MIMO channel information;
receiving a control signal indicating whether SU-MIMO or multi-user MIMO (MU-MIMO) is used and a specific MU-MIMO scheme;
receiving MIMO transmission; and
processing the MIMO transmission based on the control signal.

10. The method of claim 9 further comprising:
sending a channel quality indicator (CQI) computed based on an SU-MIMO signal-to-interference and noise ratio (SINR) ignoring an inter-user interference.

11. The method of claim 10 further comprising:
sending a second CQI indicating an inter-user interference in MU-MIMO.

12. The method of claim 9 further comprising:
sending a second index to a preferred interference matrix.

13. The method of claim 9 wherein the MIMO channel estimation is performed for a plurality of cells that are participating for multi-cell MIMO and one of the index to the SU-MIMO pre-coding matrix or the SU-MIMO channel information for each of the cells is sent to a serving cell.

14. The method of claim 9 wherein a same control channel format is used for SU-MIMO and MU-MIMO and preceding vectors/matrices are signaled by using dedicated reference signals (RSs).

15. A method implemented in a wireless transmit/receive unit (WTRU) for performing multiple-input multiple-output (MIMO) wireless communications, the method comprising:
performing MIMO channel estimation to obtain a channel matrix;
sending rank information along with one of multiple right singular vectors for multi-user MIMO (MU-MIMO) or an index to a pre-coding matrix for MU-MIMO;
receiving MIMO transmission; and
processing the MIMO transmission.

16. The method of claim 15 wherein the channel matrix is obtained for a plurality of cells that are participating for multi-cell MIMO, and one of the right singular vectors or the index to the pre-coding matrix for MU-MIMO for the plurality of cells are sent to a serving cell.

17. An apparatus for performing multiple-input multiple-output (MIMO) wireless communications, the apparatus comprising:
a plurality of antennas;
a transmitter;
a receiver; and
a processor configured to receive one of an index to a pre-coding matrix in a single user MIMO (SU-MIMO) pre-coding codebook or SU-MIMO channel information from a plurality of wireless transmit/receive units (WTRUs) and adaptively perform one of SU-MIMO or multi-user MIMO (MU-MIMO) based on a predetermined criterion, wherein channel information for performing MU-MIMO is obtained based on one of the pre-coding matrix of the SU-MIMO pre-coding codebook or the SU-MIMO channel information received from the WTRUs.

18. The apparatus of claim 17 wherein the processor is configured to determine whether a unitary MU-MIMO codebook is a subset of the SU-MIMO pre-coding codebook, override a rank requested by a WTRU on a condition that the unitary MU-MIMO codebook is a subset of the SU-MIMO pre-coding codebook, and perform a unitary pre-coding MU-MIMO.

19. The apparatus of claim 17 wherein the processor is configured to determine whether a unitary MU-MIMO codebook is a subset of the SU-MIMO pre-coding codebook, find a MU-MIMO pre-coding matrix with a largest correlation to the pre-coding matrix on a condition that the unitary MU-MIMO codebook is not a subset of the SU-MIMO pre-coding codebook, and perform a unitary pre-coding MU-MIMO.

20. The apparatus of claim 17 wherein the processor is configured to perform one of zero-forcing MU-MIMO, block diagonalization MU-MIMO, multi-cell MIMO, or beamforming MIMO based on the channel information.

21. The apparatus of claim 17 wherein the processor is configured to receive one of the index to the pre-coding matrix in the SU-MIMO pre-coding codebook or the SU-MIMO channel information for a plurality of cells that are participating for multi-cell MIMO and perform multi-cell MIMO.

22. The apparatus of claim 17 wherein the processor is configured to use a vector from a quantization codebook that has a largest correlation to the pre-coding matrix as the channel information for performing MU-MIMO.

23. The apparatus of claim 17 wherein the processor is configured to receive a channel quality indicator (CQI) computed based on SU-MIMO signal-to-interference and noise ratio (SINR) and adaptively perform one of SU-MIMO or MU-MIMO based on the CQI.

24. The apparatus of claim 23 wherein the processor is configured to receive a second CQI indicating an inter-user interference in MU-MIMO and adaptively perform one of SU-MIMO or MU-MIMO based on the second CQI.

25. A wireless transmit/receive unit (WTRU) for performing multiple-input multiple-output (MIMO) wireless communications, the WTRU comprising:
a plurality of antennas;
a transmitter;
a receiver configured to receive MIMO transmission; and
a processor configured to perform MIMO channel estimation, send one of an index to a single user MIMO (SU-MIMO) pre-coding matrix in a code book or SU-MIMO channel information, receive a control signal indicating whether SU-MIMO or multi-user MIMO (MU-MIMO) is used and a specific MU-MIMO scheme, and process the MIMO transmission based on the control signal.

26. The WTRU of claim 25 wherein the processor is configured to send a channel quality indicator (CQI) computed based on SU-MIMO signal-to-interference and noise ratio (SINR) ignoring an inter-user interference.

27. The WTRU of claim 26 wherein the processor is configured to send a second CQI indicating an inter-user interference in MU-MIMO.

28. The WTRU of claim 25 wherein the processor is configured to send a second index to a preferred interference matrix.

29. The WTRU of claim 25 wherein the processor is configured to perform the MIMO channel estimation for a plurality of cells that are participating for multi-cell MIMO and send one of the index to the SU-MIMO pre-coding matrix or the SU-MIMO channel information for each of the cells to a serving cell.

30. The WTRU of claim 25 wherein a same control channel format is used for SU-MIMO and MU-MIMO and preceding vectors/matrices are signaled by using dedicated reference signals (RSs).

31. A wireless transmit/receive unit (WTRU) for performing multiple-input multiple-output (MIMO) wireless communications, the WTRU comprising:
a plurality of antennas;
a transmitter;
a receiver configured to receive MIMO transmission; and
a processor configured to perform MIMO channel estimation to obtain a channel matrix, send rank information along with one of multiple right singular vectors for multi-user MIMO (MU-MIMO) or an index to a pre-coding matrix for MU-MIMO, and process the MIMO transmission.

32. The WTRU of claim 31 wherein the controller is configured to obtain the channel matrix for a plurality of cells that are participating for multi-cell MIMO, and send one of the right singular vectors or the index to the pre-coding matrix for MU-MIMO for the plurality of cells to a serving cell.
